(19) United States
(12) Patent Application Publication
(10) Pub. No.: US 2010/0073471 A1
(43) Pub. Date: Mar. 25, 2010

(54) Video Display Device and Video Display Method

(75) Inventor: Kiyoshi Mochiduki, Chofu-shi (JP)

Correspondence Address: BLAKELY SOKOLOFF TAYLOR & ZAFMAN LLP, 1279 OAKMEAD PARKWAY, SUNNYVALE, CA, 94085-4040, US

(73) Assignee: KABUSHIKI KAISHA TOSHIBA, Tokyo (JP)

(21) Appl. No.: 12/359,121

(22) Filed: Jan. 23, 2009

(30) Foreign Application Priority Data
Sep. 24, 2008 (JP) 2008-244252

(51) Int. Cl. H04N 7/18

(52) U.S. Cl. 348/77

(57) ABSTRACT

A video display device includes a demodulator configured to demodulate a video signal, a display unit configured to display the video signal demodulated in the demodulator, and an eyesight decline determination unit configured to determine whether or not an environment of viewing the display unit becomes a cause of an eyesight decline.

### CROSS-REFERENCE TO RELATED APPLICATION

This application is based upon and claims the benefit of priority from the prior Japanese Patent Application No. 2008-244252, filed on Sep. 24, 2008; the entire contents of which are incorporated herein by reference.

### BACKGROUND OF THE INVENTION

1. Field of the Invention

The present invention relates to a video display device and a video display method.

2. Description of the Related Art

A conventional video display device was not provided with a function for preventing an eyesight decline. Therefore, there was a problem that the eyesight decline of a viewer progresses before he or she is aware of it. Accordingly, there has been proposed a device which measures a distance between the video display device and the viewer, to thereby determine whether or not the measurement result becomes a cause of the eyesight decline, and when the measurement result is determined to be the cause of the eyesight decline, it gives an alarm and adjusts an illuminance of a lighting device (JP-A 11-133937 (KOKAI))

### BRIEF SUMMARY OF THE INVENTION

However, when the device disclosed in JP-A 11-133937 is applied, it takes time to attach the device to the video display device. Further, a viewing time and a sharpness level of video being causes of the eyesight decline are not taken into consideration. Furthermore, the alarm is only given by a sound, so that one cannot know what is the cause of the eyesight decline. In view of the above, the present invention has its object to obtain a video display device and a video display method determining an eyesight decline caused by viewing the video display device.

A video display device according to one aspect of the present invention includes: a demodulator configured to demodulate a video signal; a display unit configured to display the video signal demodulated in the demodulator; and an eyesight decline determination unit configured to determine whether or not an environment of viewing the display unit becomes a cause of the eyesight decline.

A video display method according to one aspect of the present invention includes: demodulating a video signal; displaying the video signal demodulated in a demodulator; and determining whether or not an environment of viewing a display unit becomes a cause of an eyesight decline.

### BRIEF DESCRIPTION OF THE DRAWINGS

FIG. 1 is a block diagram showing an example of a configuration of a video display device according to a first embodiment.

FIG. 2 is a block diagram showing an example of a detailed configuration of a sharpness measurement unit.

FIG. 3A is a view showing information stored in a storage unit.

FIG. 3B is a view showing information stored in the storage unit.

FIG. 4 is a block diagram showing an example of a detailed configuration of a sharpness control section.

FIG. 5 is a flow chart showing a calculation method of eyesight decline coefficients.

FIG. 6 is a flow chart showing a determination method of the eyesight decline.

FIG. 7 is a flow chart showing a video switching operation.

FIG. 8 is a block diagram showing an example of a configuration of a video display device according to a second embodiment.

FIG. 9A is a view showing information stored in a storage unit.

FIG. 9B is a view showing information stored in the storage unit.

FIG. 10 is a flow chart showing a video switching operation.

### DETAILED DESCRIPTION OF THE INVENTION

Hereinafter, embodiments of the present invention will be described in detail with reference to the drawings.

### First Embodiment

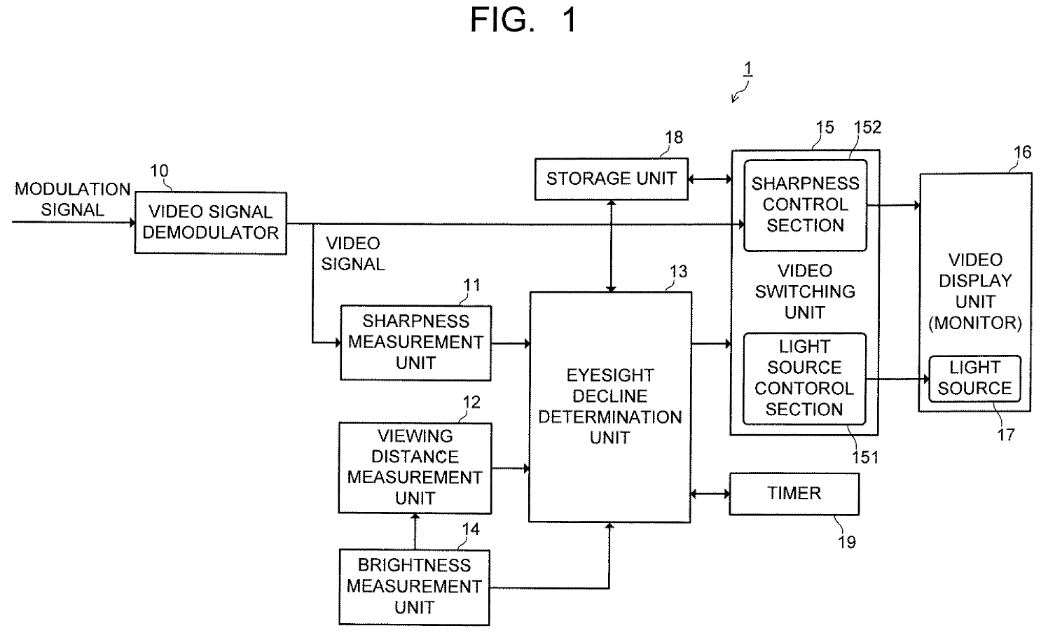

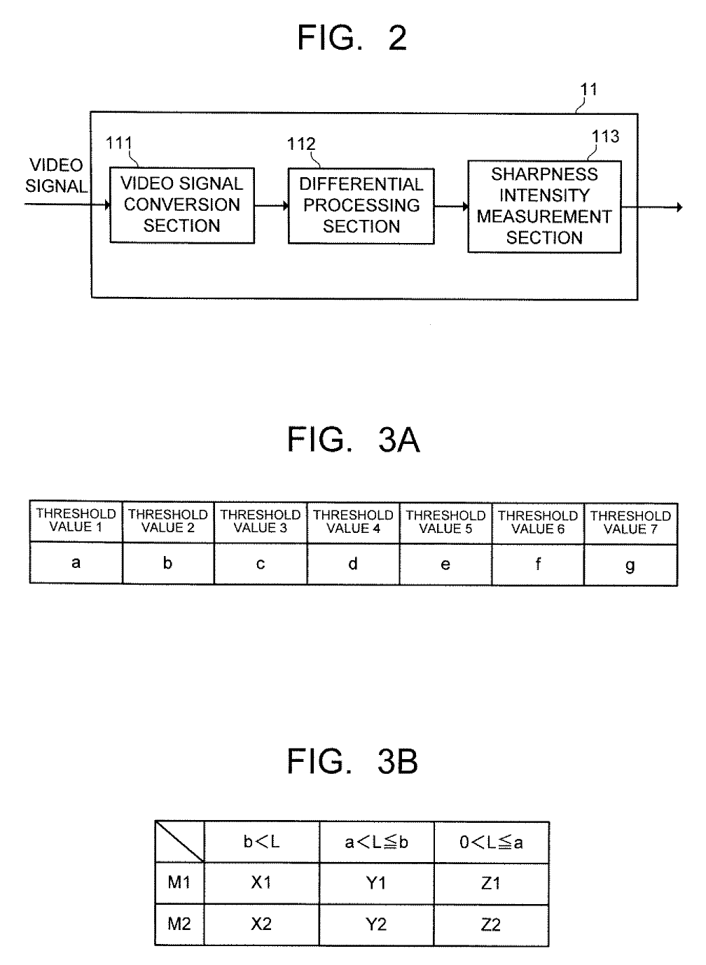

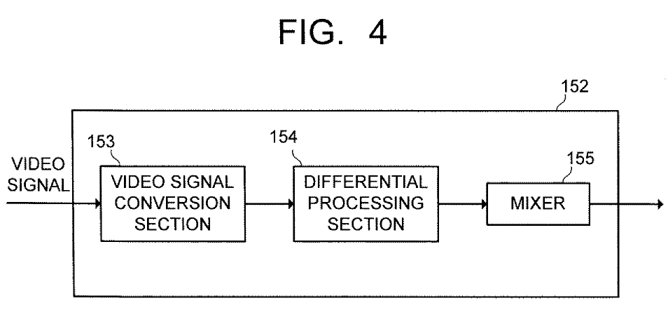

FIG. 1 is a block diagram showing an example of a configuration of a video display device 1 according to a first embodiment. FIG. 2 is a block diagram showing an example of a detailed configuration of a sharpness measurement unit 11. FIGS. 3A and 3B are views showing information stored in a storage unit 18. FIG. 4 is a block diagram showing an example of a detailed configuration of a sharpness control section 152.

Note that in the first embodiment, a liquid crystal television will be explained as an example of the video display device 1. However, various video display devices such as a cathode ray tube television and an organic EL television, other than the liquid crystal television, can be used as the video display device 1.

The video display device 1 according to the first embodiment includes: a video signal demodulator 10 (demodulator); the sharpness measurement unit 11 (fourth measurement unit); a viewing distance measurement unit 12 (first measurement unit); an eyesight decline determination unit 13; a brightness measurement unit 14 (third measurement unit); a video switching unit 15 (video adjusting unit); a video display unit 16 (display unit); a light source 17 (backlight); the storage unit 18; and a timer 19 (second measurement unit).

The video signal demodulator 10 demodulates a video signal input from the outside such as the one input from an antenna. The sharpness measurement unit 11 measures, from the video signal input from the video signal demodulator 10, a sharpness level S of the video.

As shown in FIG. 2, the sharpness measurement unit 11 includes a video signal conversion section 111, a differential processing section 112 and a sharpness intensity measurement section 113. The video signal conversion section 111 converts an image signal into a YCrCb signal. The differential processing section 112 performs a differential processing in the vertical direction and horizontal direction on the YCrCb signal converted in the video signal conversion section 111, to thereby generate a differential signal. Since the processing speed is important, a first differentiation is generally used for the differential processing. However, it is known that a diffusion process being one of the basic phenomena of video and a visual characteristic have a deep relation with a second differential image. Accordingly, it is also possible that the second differential image is set as the differential image signal.

Note that a value of the differential image signal indicates an edge strength. Therefore, the value of the differential image signal becomes small at a part where there is no change in the image or at a part where the image changes moderately. Further, the value of the differential image signal becomes large at a part where the image changes rapidly.

The sharpness intensity measurement section 113 measures the sharpness level S from the differential image signal generated in the differential processing section 112. Concretely, the sharpness intensity measurement section 113 calculates a histogram (distribution chart) indicating a correspondence between the value of the differential image signal and the number of pixels. Next, the sharpness intensity measurement section 113 calculates, from a maximum value in the histogram, a frequency value which occupies any ratio between 3% to 10% of the total number of pixels. Subsequently, the value of the differential image signal corresponding to the frequency value is set as the sharpness level S.

The reason why the maximum value of the differential image signal is not adopted as the sharpness level S is as follows. When an edge caused by noise and the like is generated, it is conceivable that the edge caused by noise and the like is measured as the maximum value of the differential image signal. Therefore, there is a problem for directly adopting the obtained maximum value of the differential image signal as the sharpness level S. Accordingly, in the present embodiment, the value of the differential image signal corresponding to the frequency value which occupies any ratio between 3% to 10% of the total number of pixels obtained from the maximum value in the calculated histogram is adopted as the sharpness level S.

The brightness measurement unit 14 includes optical sensors A and B. The optical sensor A is provided at an upper portion of the video display device 1 and measures a brightness of a room (space) and the like in which the video display unit 16 is viewed (hereinafter, referred to as illuminance I). The measurement result is input into the eyesight decline determination unit 13. Further, the optical sensor B is provided at a lower portion of a front surface of the video display device 1 and measures an illuminance. The measurement result made by the optical sensor B is input into the viewing distance measurement unit 12 and is used for measuring a distance between a not-shown viewer and the video display device 1 (hereinafter, referred to as viewing distance L).

The viewing distance measurement unit 12 calculates the viewing distance L based on the measurement result input from the optical sensor B of the brightness measurement unit 14. Because the optical sensor B is provided at the lower portion of the front surface of the video display device 1, there is an influence of a shadow of the viewer on the measurement of the illuminance conducted in the brightness measurement unit 14. If the viewing distance L is short, the influence of the shadow of the viewer which appears in the brightness measurement unit 14 increases. Accordingly, the illuminance I measured in the brightness measurement unit 14 becomes small. Further, if the viewing distance L is long, the influence of the shadow of the viewer which appears in the brightness measurement unit 14 decreases. Accordingly, the illuminance I measured in the brightness measurement unit 14 becomes large.

Accordingly, by previously measuring a relation between the viewing distance L and the illuminance I measured in the brightness measurement unit 14, it is possible to calculate the viewing distance L based on the illuminance I measured in the brightness measurement unit 14. Note that it is also possible to configure that the optical sensors A and B are formed by one optical sensor and an illuminance measured by the one optical sensor is input into the eyesight decline determination unit 13 and the viewing distance measurement unit 12. As the optical sensors A and B provided in the brightness measurement unit 14, photodiodes and the like can be used. However, the optical sensors A and B are not limited only to the photodiodes.

Note that various methods can be adopted as a measuring method of the viewing distance L. For instance, if a video display device including an image-capturing unit (camera) is used, it is also possible to calculate the viewing distance L based on an image captured by the camera. Specifically, it is also possible that a size of the viewer at a predetermined distance on the captured image is previously registered and the viewing distance L is calculated based on the size of the viewer captured in the captured image using a trigonometric function. Further, it is also possible that an ultrasonic generator and an ultrasonic receiver are provided, and the viewing distance L is calculated based on a difference between a time at which an ultrasonic wave is emitted from the ultrasonic generator and a time at which a reflected wave of the ultrasonic wave is received by the ultrasonic receiver.

Further, it is also possible that an infrared ray is transmitted to the viewer, and the viewing distance is calculated based on a time at which a reflected wave of the infrared ray is received, for instance. Furthermore, since the viewer tends to put a remocon on his or her side at the time of viewing, the viewing distance can also be calculated by detecting a position of the remocon.

The storage unit 18 stores information necessary for determinations performed at the eyesight decline determination unit 13 and the video switching unit 15. FIGS. 3A and 3B are views showing information stored in the storage unit 18.

FIG. 3A is a view showing threshold value information stored in the storage unit 18. A threshold value 1 and a threshold value 2 are threshold values corresponding to the viewing distance L. The threshold value 1 and the threshold value 2 are previously decided based on a size or a use (for TV (Television) or for PC (Personal Computer)) of the video display unit 16. Specifically, the threshold value 1 and the threshold value 2 become large and extended in proportion to the size of the video display unit 16. Further, the TV and the PC are configured on the assumption that the TV is viewed from a great distance and the PC is viewed from a close distance. For this reason, the threshold value 1 and the threshold value 2 for TV are set to have extended values compared to the threshold value 1 and the threshold value 2 for PC. Note that there is a relation expressed by the formula: threshold value 1<threshold value 2 (a<b). Values of the threshold value 1 and the threshold value 2 are respectively set as a and b. Actually, the values of the threshold value 1 and the threshold value 2 are decided based on an experimental result and a test result. Note that in the first embodiment, since an optimum viewing distance for viewing TV normally falls in a range of 1m to 2m, a and b are respectively set as 1m and 2m.

A threshold value 3 is a threshold value corresponding to the illuminance I. The threshold value 3 is a threshold value previously decided based on a size (inch) or a use (for TV (Television) or for PC (Personal Computer)) of a screen. A unit of the threshold value 3 is lux (x1). A value of the threshold value 3 is set as c. Actually, the value of the threshold value 3 is decided based on an experimental result and a test result.

A threshold value 4 is a threshold value corresponding to the sharpness level S. The sharpness level S is a value which indicates the degree of enhancement of a contour of video displayed on the video display unit 16. The larger the sharpness level S becomes, the more the contour of video displayed on the video display unit 16 is enhanced. A value of the threshold value 4 is set as d. Actually, the value of the threshold value 4 is decided based on an experimental result and a test result.

A threshold value 5, a threshold value 6 and a threshold value 7 are threshold values corresponding to eyesight decline determination values V1, V2 and V. These eyesight decline determination values V1, V2 and V are calculated through later-described formula (1), formula (2) and formula (3). The eyesight decline determination value V is used for a determination of eyesight decline performed at the eyesight decline determination unit 13. The eyesight decline determination values V1 and V2 are used for a determination performed at the video switching unit 15. Values of the threshold value 5, the threshold value 6 and the threshold value 7 are respectively set as e, f and g. Actually, the values of the threshold value 5, the threshold value 6 and the threshold value 7 are decided based on an experimental result and a test result.

FIG. 3B is a view showing a correspondence among the viewing distance L and eyesight decline coefficients M1 and M2. The eyesight decline coefficient M1 is a coefficient used for calculating the eyesight decline determination value V1. Further, the eyesight decline coefficient M2 is a coefficient used for calculating the eyesight decline determination value V2.

When the viewing distance L is equal to or shorter than the threshold value 1(a), values of the eyesight decline coefficients M1 and M2 become Z1 and Z2. When the viewing distance L is longer than the threshold value 1(a) and is equal to or shorter than the threshold value 2(b), the values of the eyesight decline coefficients M1 and M2 become Y1 and Y2. Further, when the viewing distance L is longer than the threshold value 2(b), the values of the eyesight decline coefficients M1 and M2 become X1 and X2.

There are relations expressed by the formulas: X1<Y1<Z1 and X2<Y2<Z2. Namely, as the viewing distance L becomes longer, it is conceivable that the viewing distance L is unlikely to become the cause of the eyesight decline. For this reason, as the viewing distance L becomes longer, the values of the eyesight decline coefficients M1 and M2 are made to be small. Note that it is also possible that the viewing distance L is not classified according to the threshold value land the threshold value 2, and values obtained by multiplying an inverse number of the viewing distance L by a constant are adopted as the eyesight decline coefficients M1 and M2.

The eyesight decline determination unit 13 compares the sharpness level S measured in the sharpness measurement unit 11, the viewing distance L calculated in the viewing distance measurement unit 12, and the measurement result of the illuminance I measured in the optical sensor A of the brightness measurement unit 14, with the threshold values stored in the storage unit 18. Subsequently, according to the comparison result, the eyesight decline determination unit 13 determines whether or not a current viewing environment becomes the cause of the eyesight decline of the viewer.

The video switching unit 15 includes a light source control section 151 and a sharpness control section 152. The light source control section 151 lowers an illuminance of the light source 17 provided in the video display unit 16 in accordance with the determination result made by the eyesight decline determination unit 13. Further, the sharpness control section 152 adjusts a frequency characteristic of the video signal in accordance with the determination result made by the eyesight decline determination unit 13. By this adjustment, the sharpness of video displayed on the video display unit 16 is adjusted.

As shown in FIG. 4, the sharpness control section 152 includes a video signal conversion part 153, a differential processing part 154 and a mixer 155. The video signal conversion part 153 converts an image signal into a YCrCb signal. The differential processing part 154 performs a differential processing in the vertical direction and horizontal direction on the YCrCb signal converted in the video signal conversion part 153, to thereby generate a differential image signal. In the differential processing part 154, the differential processing is carried out by any number n (n is a natural number) of times. The mixer 155 mixes the differential image signal generated in the differential processing part 154 on which nth differentiation in the vertical direction and horizontal direction is performed, with the video signal on which the differential processing is not yet performed. By conducting the sharpness adjustment, the contour of video is enhanced, which makes the video clearer.

The video display unit 16 displays the video signal input from the video switching unit 15 as a video. The light source 17 is a backlight of the video display unit 16. The timer 19 measures time according to an instruction from the eyesight decline determination unit 13. Concretely, the timer 19 measures a time T1 during which the video display unit 16 is viewed under the state where the illuminance I is equal to or smaller than the threshold value 3(c), and a time T2 during which the video display unit 16 is viewed under the state where the sharpness level S is smaller than the threshold value 4(d).

Next, an operation will be described.

### (Calculation of Eyesight Decline Coefficient)

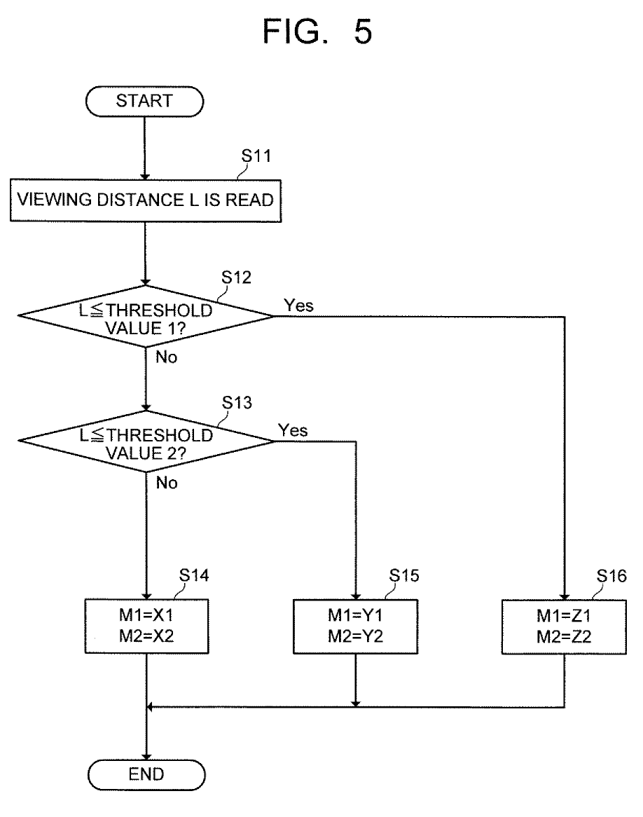

FIG. 5 is a flow chart showing a calculation method of the eyesight decline coefficients. Firstly, the eyesight decline determination unit 13 reads the viewing distance L from the viewing distance measurement unit 12 (step S11).

Next, the eyesight decline determination unit 13 determines whether or not the viewing distance L read from the viewing distance measurement unit 12 is equal to or smaller than the threshold value 1 (step S12).

When the viewing distance L is not equal to or smaller than the threshold value 1 in step S12, the eyesight decline determination unit 13 determines whether or not the viewing distance L is equal to or smaller than the threshold value 2 (step S13).

When the viewing distance L is not equal to or smaller than the threshold value 2 in step S13, the eyesight decline determination unit 13 refers to the storage unit 18 and decides the eyesight decline coefficients M1 and M2 (step S14). The viewing distance L has a relation expressed by the formula: threshold value 2<viewing distance L (b<L), so that M1 and M2 are decided to be X1 and X2, respectively.

When the viewing distance L is equal to or smaller than the threshold value 2 in step S13, the eyesight decline determination unit 13 refers to the storage unit 18 and decides the eyesight decline coefficients M1 and M2 (step S15). The viewing distance L has a relation expressed by the formula: threshold value 1<viewing distance L≦threshold value 2 (a<L≦b), so that M1 and M2 are decided to be Y1 and Y2, respectively.

When the viewing distance L is equal to or smaller than the threshold value 1 in step S12, the eyesight decline determination unit 13 refers to the storage unit 18 and decides the corresponding eyesight decline coefficients M1 and M2 (step S16). The viewing distance L has a relation expressed by the formula: 0 (zero)<viewing distance L≦threshold value 1 (0 (zero)<L≦a), so that M1 and M2 are decided to be Z1 and Z2, respectively.

### (Determination of Eyesight Decline)

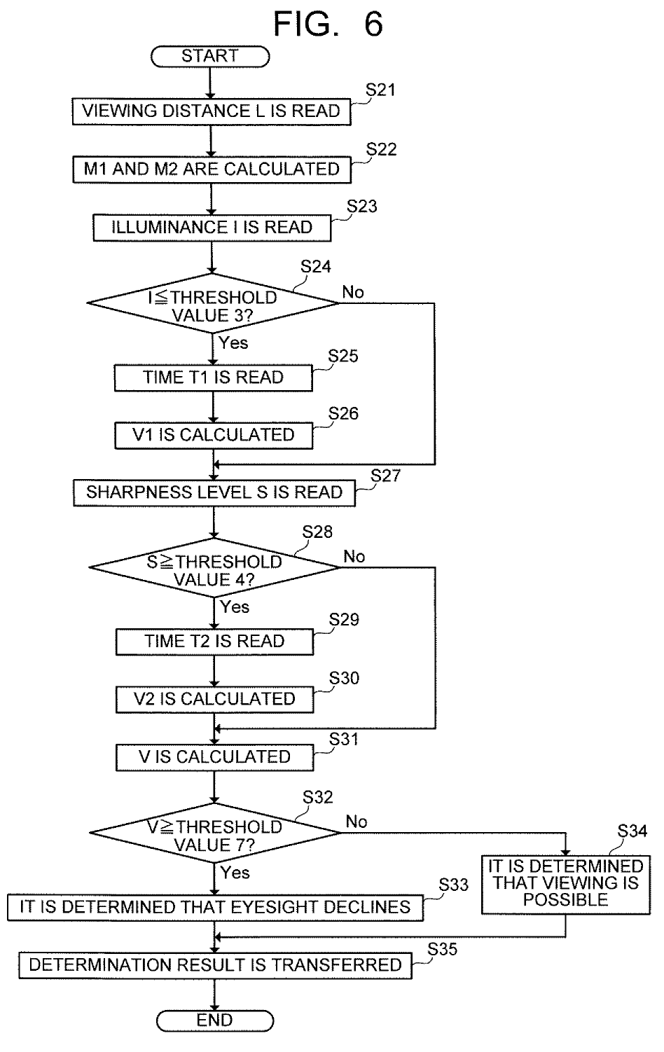

FIG. 6 is a flow chart showing a determination method of the eyesight decline. Firstly, the eyesight decline determination unit 13 reads the viewing distance L (step S21), and decides the eyesight decline coefficients M1 and M2 (step S22). Note that these steps S21 and S22 are executed by performing the processings of steps S11 to S16 explained in FIG. 5.

Next, the eyesight decline determination unit 13 reads the illuminance I measured in the brightness measurement unit 14 (step S23).

Next, the eyesight decline determination unit 13 determines whether or not the illuminance I read from the brightness measurement unit 14 is equal to or smaller than the threshold value 3 stored in the storage unit 18 (step S24).

When the illuminance I is equal to or smaller than the threshold value 3 in step S24, the eyesight decline determination unit reads the time T1 from the timer 19 (step S25). Note that when the illuminance I is not equal to or smaller than the threshold value 3 in step S24, the eyesight decline determination unit performs operations started from later-described step S27.

Next, the eyesight decline determination unit 13 calculates the eyesight decline determination value V1 (step S26). V1 is calculated by the following formula (1).

V1=M1×T1 (1)

M1 is the eyesight decline coefficient decided in either step of steps S14 to 16. The time T1 is the time read from the timer 19 in step S25.

Subsequently, the eyesight decline determination unit 13 reads the sharpness level S from the sharpness measurement unit 11 (step S27).

Next, the eyesight decline determination unit 13 determines whether or not the sharpness level S read from the sharpness measurement unit 11 is equal to or larger than the threshold value 4 (step S28).

When the sharpness level S is smaller than the threshold value 4 in step S28, the eyesight decline determination unit reads the time T2 from the timer 19 (step S29). Note that when the sharpness level S is equal to or larger than the threshold value 4 in step S28, the eyesight decline determination unit performs operations started from later-described step S31.

Next, the eyesight decline determination unit 13 calculates the eyesight decline determination value V2 (step S30). V2 is calculated by the following formula (2).

V2=M2×T2 (2)

M2 is the eyesight decline coefficient decided in either step of steps S14 to S16. The time T2 is the time read from the timer 19 in step S29.

Subsequently, the eyesight decline determination unit 13 calculates the eyesight decline determination value V (step S31). V is calculated by the following formula (3).

V=V1+V2 (3)

V1 is the eyesight decline determination value calculated by the formula (1) in step S26. V2 is the eyesight decline determination value calculated by the formula (2) in step S30.

Note that when the illuminance I is not equal to or smaller than the threshold value 3 in step S24, V is calculated by assuming that V1 is 0 (zero). Further, when the sharpness level S is equal to or larger than the threshold value 4 in step S28, V is calculated by assuming that V2 is 0 (zero).

Next, the eyesight decline determination unit 13 determines whether or not the eyesight decline determination value V calculated in step S31 is equal to or larger than the threshold value 7 stored in the storage unit 18 (step S32).

When the eyesight decline determination value V is equal to or larger than the threshold value 7 in step S32, the eyesight decline determination unit 13 determines that the viewing environment corresponds to the cause of the eyesight decline (step S33).

Further, when the eyesight decline determination value V is smaller than the threshold value 7 in step S32, the eyesight decline determination unit 13 determines that the viewing environment does not correspond to the cause of the eyesight decline and it is possible to continuously view the video display unit 16 (step S34).

Subsequently, the eyesight decline determination unit notifies the video switching unit of the determination result made in step S33 or step S34 (step S35). At this time, the eyesight decline determination unit also notifies the video switching unit of the eyesight decline determination value V1 calculated in step S26 and the eyesight decline determination value V2 calculated in step S30.

### (Video Switching Operation)

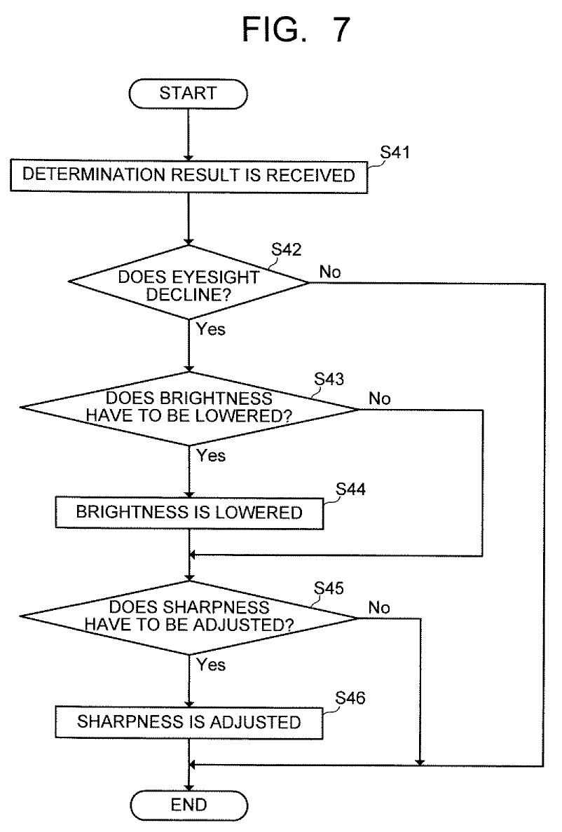

FIG. 7 is a flow chart showing an operation of the video switching unit 15. Firstly, the video switching unit 15 receives the determination result and the eyesight decline determination values V1 and V2 notified from the eyesight decline determination unit 13 (step S41).

Next, the video switching unit 15 determines whether or not the determination result notified from the eyesight decline determination unit 13 corresponds to the one indicating the eyesight decline (step S42). If the determination result notified from the eyesight decline determination unit 13 is the one which does not indicate the eyesight decline in step S42, the video switching unit 15 terminates its operation.

If the determination result notified from the eyesight decline determination unit 13 is the one which indicates the eyesight decline in step S42, the video switching unit 15 refers to the storage unit 18 and determines whether or not the eyesight decline determination value V1 is larger than the threshold value 5 stored in the storage unit 18 (step S43).

When the eyesight decline determination value V1 is larger than the threshold value 5 in step S43, it is conceivable that the viewer views the video display unit 16 in a dark room. Accordingly, the light source control section 151 of the video switching unit 15 controls the light source 17 provided in the video display unit 16, thereby lowering the brightness of screen of the video display unit 16.

Further, when the eyesight decline determination value V1 is not larger than the threshold value 5 in step S43, the video switching unit 15 performs an operation of later-described step S45.

Next, the video switching unit 15 refers to the storage unit 18 and determines whether or not the eyesight decline determination value V2 is larger than the threshold value 6 stored in the storage unit 18 (step S45).

When the eyesight decline determination value V2 is larger than the threshold value 6 in step S45, it is conceivable that the viewer views the video display unit 16 while the contour of video displayed on the video display unit 16 is blurred. Accordingly, the sharpness control section 152 of the video switching unit 15 performs the sharpness adjustment of the video display device 1, thereby enhancing the contour of video (step S46).

Further, when the eyesight decline determination value V2 is not larger than the threshold value 6 in step S45, the video switching unit 15 terminates its operation. Note that the video display device 1 performs the operations explained in FIG. 5 to FIG. 7 at every predetermined time.

As described above, the video display device 1 according to the first embodiment measures the viewing time, the brightness of the room, the sharpness level of video, and the like. Subsequently, the video display device 1 determines whether or not the current viewing environment becomes the cause of the eyesight decline of the viewer. Further, the video display device 1 is designed to perform the sharpness adjustment and the illuminance adjustment of the video display unit 16 according to the determination result.

Accordingly, it is possible to effectively prevent the eyesight decline caused by viewing the video display device 1. Further, it is possible to perform a control in which the viewing time and the sharpness level of video which are the causes of the eyesight decline are taken into consideration. Furthermore, the function of preventing the eyesight decline is previously included in the video display device 1, so that the time taken for attaching the device to the video display device 1, which was conventionally required, is eliminated.

### Second Embodiment

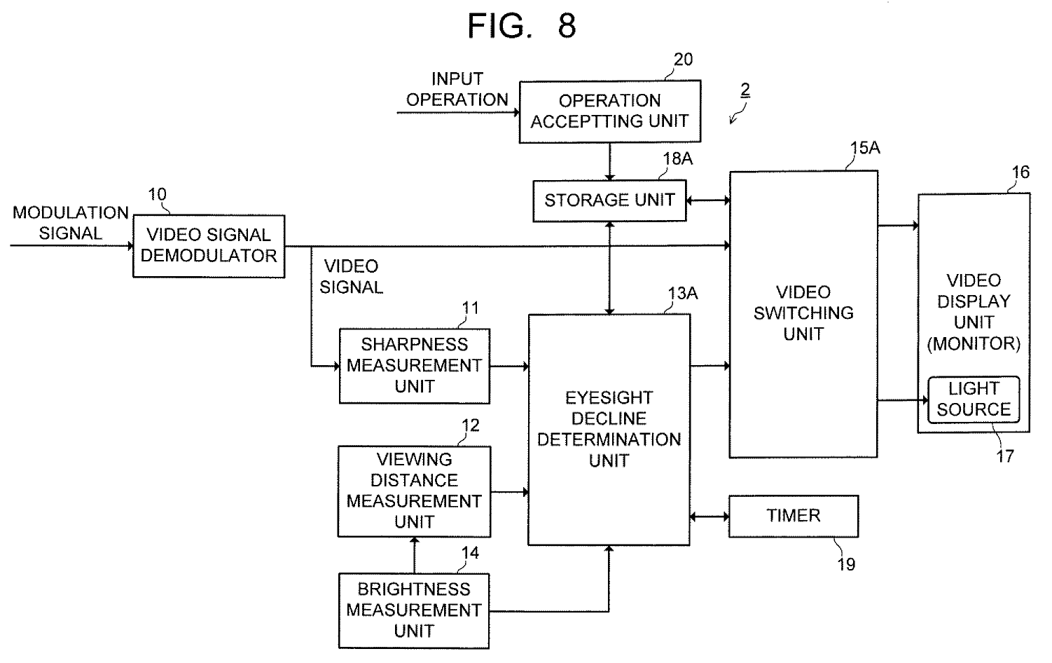

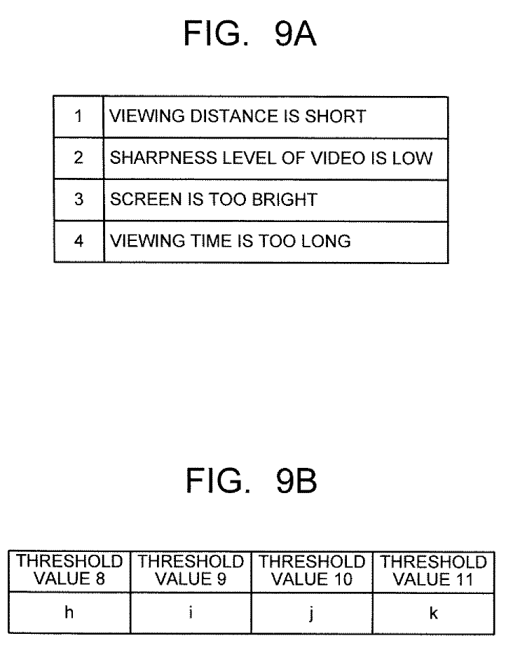

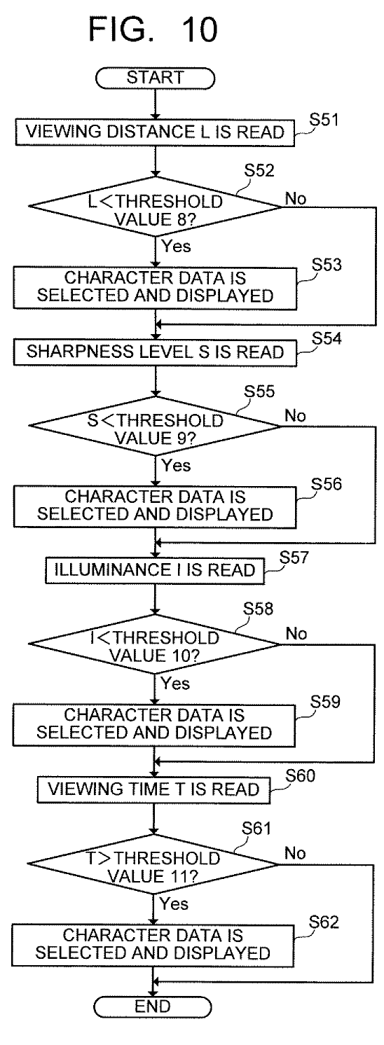

FIG. 8 is a block diagram showing an example of a configuration of a video display device 2 according to a second embodiment. FIGS. 9A and 9B are views showing information stored in a storage unit 18A. FIG. 10 is a flow chart showing an operation of the video display device 2.

In the second embodiment, an operation accepting unit 20 is provided and threshold values stored in the storage unit 18A can be changed. Further, when an eyesight decline is determined at an eyesight decline determination unit 13A, a cause of the eyesight decline is displayed on the video display unit 16, to thereby call a viewer's attention.

The operation accepting unit 20 accepts a changing operation of the threshold values performed by the viewer of the video display device 2. In addition, the operation accepting unit 20 changes the threshold values stored in the storage unit 18A in accordance with the accepted changing operation.

FIG. 9A is a view showing pieces of display information stored in the storage unit 18A. The pieces of display information indicate the causes of the eyesight decline. The storage unit 18A stores the following pieces of display information.
1. “Viewing distance is short”
2. “Sharpness level of video is low”
3. “Screen is too bright”
4. “Viewing time is too long”

FIG. 9B is a view showing the threshold values stored in the storage unit 18A. A threshold value 8 is a threshold value corresponding to the viewing distance L. A threshold value 9 is a threshold value corresponding to the sharpness level S. A threshold value 10 is a threshold value corresponding to the illuminance I. A threshold value 11 is a threshold value corresponding to a viewing time T. Values of the threshold value 8 to the threshold value 11 are set as h, i, j and k, respectively. Actually, the values are decided based on an experimental result and a test result. Note that in the second embodiment, h is set to indicate 1m to 2m. Further, i is set to indicate whether or not there is a difference of 10% or more in tone among 256 gradations. Furthermore, j is set to indicate 400 luxes to 500 luxes. In addition, k is set to indicate one hour. Further, as described above, it is possible to change the threshold values stored in the storage unit 18A with the use of the operation accepting unit 20.

According to a comparison result obtained by comparing the sharpness level S measured in the sharpness measurement unit 11, the viewing distance L calculated in the viewing distance measurement unit 12, the illuminance I measured in the brightness measurement unit 14, and the viewing time T measured by the timer 19, with the threshold values stored in the storage unit 18A, the eyesight decline determination unit 13A obtains the display information stored in the storage unit 18A.

A video switching unit 15A (overlapping unit) displays the display information obtained by the eyesight decline determination unit 13A, on the video display unit 16, while overlapping it with the video signal. Note that a place where the display information is displayed can be an upper portion or lower portion of the video display unit 16 so that it does not become a hindrance at the time of viewing.

Note that since other constituent features were explained in FIG. 1, the same components are designated by the same reference numerals and an overlapping explanation thereof will be omitted.

Next, an operation will be explained. FIG. 10 is a flow chart showing a display operation of the display information performed by the eyesight decline determination unit 13A and the video switching unit 15A. Firstly, the eyesight decline determination unit 13A reads the viewing distance L from the viewing distance measurement unit 12 (step S51).

Next, the eyesight decline determination unit 13A refers to the storage unit 18A. Subsequently, the eyesight decline determination unit 13A determines whether or not the viewing distance L read from the viewing distance measurement unit 12 is smaller than the threshold value 8 (step S52). When the viewing distance L is equal to or larger than the threshold value 8 in step S52, the eyesight decline determination unit 13A performs an operation of later-described step S54.

When the viewing distance L is smaller than the threshold value 8 in step S52, the eyesight decline determination unit 13A refers to the storage unit 18A and obtains the display information “Viewing distance is short”. Next, the eyesight decline determination unit 13A outputs the obtained display information “Viewing distance is short” to the video switching unit 15A. The video switching unit 15A displays the display information “Viewing distance is short” on the video display unit 16 while overlapping it with the video signal (step S53).

Subsequently, the eyesight decline determination unit 13A reads the sharpness level S from the sharpness measurement unit 11 (step S54). Next, the eyesight decline determination unit 13A refers to the storage unit 18A and determines whether or not the sharpness level S read from the sharpness measurement unit 11 is smaller than the threshold value 9 (step S55). When the sharpness level S is equal to or larger than the threshold value 9 in step S55, the eyesight decline determination unit 13A performs an operation of later-described step S57.

When the sharpness level S is smaller than the threshold value 9 in step S55, the eyesight decline determination unit 13A refers to the storage unit 18A and obtains the display information “Sharpness level of video is low”. Next, the eyesight decline determination unit 13A outputs the obtained display information “Sharpness level of video is low” to the video switching unit 15A. The video switching unit 15A displays the display information “Sharpness level of video is low” on the video display unit 16 while overlapping it with the video signal (step S56).

Subsequently, the eyesight decline determination unit 13A reads the illuminance I from the brightness measurement unit 14 (step S57). Next, the eyesight decline determination unit 13A refers to the storage unit 18A and determines whether or not the illuminance I read from the brightness measurement unit 14 is smaller than the threshold value 10 (step S58). When the illuminance I is equal to or larger than the threshold value 10 in step S58, the eyesight decline determination unit 13A performs an operation of later-described step S60.

When the illuminance I is smaller than the threshold value 10 in step S58, the eyesight decline determination unit 13A refers to the storage unit 18A and obtains the display information “Screen is too bright”. Next, the eyesight decline determination unit 13A outputs the obtained display information “Screen is too bright” to the video switching unit 15A. The video switching unit 15A displays the display information “Screen is too bright” on the video display unit 16 while overlapping it with the video signal (step S59).

Subsequently, the eyesight decline determination unit 13A reads the viewing time T from the timer 19 (step S60). Next, the eyesight decline determination unit 13A refers to the storage unit 18A and determines whether or not the viewing time T read from the timer 19 is longer than the threshold value 11 (step S61). When the viewing time T is equal to or shorter than the threshold value 11 in step S61, the eyesight decline determination unit 13A terminates its operation.

When the viewing time T is longer than the threshold value 11 in step S61, the eyesight decline determination unit 13A refers to the storage unit 18A and obtains the display information “Viewing time is too long”. Next, the eyesight decline determination unit 13A outputs the obtained display information “Viewing time is too long” to the video switching unit 15A. The video switching unit 15A displays the display information “Viewing time is too long” on the video display unit 16 while overlapping it with the video signal (step S62).

Note that the video display device 2 repeatedly performs the operation explained in FIG. 10 at every predetermined time.

As described above, the video display device 2 according to the second embodiment is designed to measure the viewing distance, the viewing time, the brightness of the room, the sharpness level of video and the like, and to display, according to the comparison result obtained by comparing the respective measurement results with the threshold values, the display information indicating the cause of the eyesight decline on the video display unit 16.

Accordingly, the viewer can recognize that he or she is in an environment where the eyesight declines. Further, the viewer can recognize the cause of the eyesight decline. Furthermore, the operation accepting unit 20 is provided and the threshold values stored in the storage unit 18A can be changed, so that the usability for the viewer is improved.

### Other Embodiments

Note that the present invention is not limited directly to the aforementioned embodiments, and can be embodied by modifying its components without departing from the gist of the present invention in a phase of execution. For instance, the present invention can be executed by combining the first embodiment with the second embodiment. In this case, the viewing time, the brightness of the room, the sharpness level of video and the like are measured to determine the eyesight decline, and based on the determination result, the sharpness adjustment and the illuminance adjustment of the video display unit 16 are performed, and the display information is displayed on the video display unit 16, to thereby call the viewer's attention. Further, it is also possible that a flickering of video or a blur of color, other than the sharpness level, is measured as the cause of the eyesight decline, and the measurement result is used for the determination of the eyesight decline. As above, the present invention can be widely applied to devices which determine whether or not the eyesight decline is caused, based on the viewing environment, the video and the like, and can contribute to the prevention of the eyesight decline of the viewer.

What is claimed is:

1. A video display device, comprising:
a demodulator configured to demodulate a video signal;
a display unit configured to display the video signal demodulated in the demodulator; and
an eyesight decline determination unit configured to determine whether or not an environment of viewing the display unit becomes a cause of an eyesight decline.

2. The video display device of claim 1, further comprising,
a first measurement unit configured to measure a distance between a viewer and the video display unit,
wherein the eyesight decline determination unit performs a determination of eyesight decline according to the distance measured in the first measurement unit.

3. The video display device of claim 1, further comprising,
a second measurement unit configured to measure a viewing time,
wherein the eyesight decline determination unit performs a determination of eyesight decline according to the viewing time measured in the second measurement unit.

4. The video display device of claim 1, further comprising,
a third measurement unit configured to measure an illuminance of a viewing space,
wherein the eyesight decline determination unit performs a determination of eyesight decline according to the illuminance measured in the third measurement unit.

5. The video display device of claim 1, further comprising,
a fourth measurement unit configured to measure a sharpness level of video,
wherein the eyesight decline determination unit performs a determination of eyesight decline according to the sharpness level of video measured in the fourth measurement unit.

6. The video display device of claim 4, further comprising,
a video adjusting unit configured to adjust an illuminance of the display unit according to a determination result made by the eyesight decline determination unit.

7. The video display device of claim 5, further comprising,
a video adjusting unit configured to adjust a sharpness of video of the display unit according to a determination result made by the eyesight decline determination unit.

8. A video display device, comprising:
a demodulator configured to demodulate a video signal;
a display unit configured to display the video signal demodulated in the demodulator;
a storage unit configured to store a plurality of pieces of display information indicating causes of eyesight decline;
an eyesight decline determination unit configured to determine whether or not an environment of viewing the display unit becomes the cause of the eyesight decline and selecting, according to the determination result, either of the plurality of pieces of display information from the storage unit; and
an overlapping unit configured to display the display information selected by the eyesight decline determination unit while overlapping it with a video on the display unit.

9. A video display method, comprising:
demodulating a video signal;
displaying the video signal demodulated in a demodulator; and
determining whether or not an environment of viewing the displayed video becomes a cause of an eyesight decline.
